(19) United States
(12) Patent Application Publication
(10) Pub. No.: US 2024/0324633 A1
(43) Pub. Date: Oct. 3, 2024

(54) ALGAL HEME ANALOG

(71) Applicant: BACK OF THE YARDS ALGAE SCIENCES LLC, Chicago, IL (US)

(72) Inventors: Leonard LERER, Chicago, IL (US); Jiyan CEN, Chicago, IL (US)

(21) Appl. No.: 18/681,612

(22) PCT Filed: Aug. 4, 2022
(86) PCT No.: PCT/US2022/039365

§ 371 Date: Feb. 6, 2024

Related U.S. Application Data
(60) Provisional application No. 63/230,155, filed on Aug. 6, 2021.

(51) Int. Cl. A23L 5/46; A23J 3/16; A23J 3/18; C07F 15/02

(52) U.S. Cl. CPC A23L 5/46; A23J 3/16; A23J 3/18; C07F 15/025

(57) ABSTRACT

The present invention provides iron-complexed phycocyanobilin (PCB) compounds and in particular compositions and food products containing iron-complexed phycocyanobilin (PCB) compounds.

### CROSS-REFERENCE TO RELATED APPLICATION

The present application claims priority to U.S. Provisional Patent Application No. 63/230,155, filed Aug. 6, 2021, which is hereby incorporated by reference in its entirety.

### FIELD OF THE INVENTION

The present invention provides iron-complexed phycocyanobilin (PCB) compounds and in particular compositions and food products containing iron-complexed phycocyanobilin (PCB) compounds.

### BACKGROUND OF THE INVENTION

Phycocyanin (PC) is a pigment protein found in algae. It plays an important role in photosynthesis through its capacity to interact with photons of visible light. Methods for its efficient extraction and purification have been developed, allowing for large scale production. See, e.g., PCT Appl. PCT/US2019/061709. PC has found use in a number of applications, including as an agricultural nutrient and a nutritional coloring agent.

Recently, a number of plant-based meat substitutes have been introduced into the market, including products such as the Impossible Burger™M. These products include the non-animal heme substitutes which lend organoleptic properties to the products. These products are described in U.S. Pat. Nos. 10,327,464; 10,314,325; 10,172,381; 10,039,306; 9,943,096; and 9,833,786 and US Publ. Nos. 20190200658; 20190116855; 2019008192; 20180199606; 20180199605; 20180192680; 20180168209; 20170112175; 20160340411; 20150305390 and 20170188612; all of which are incorporated by reference herein in their entirety.

What is needed in the art are improved heme-substitutes from non-animal sources.

### SUMMARY OF THE INVENTION

The present invention provides iron-complexed phycocyanobilin (PCB) compounds and in particular compositions and food products containing iron-complexed phycocyanobilin (PCB) compounds.

In some preferred embodiments, the present invention provides a compound comprising phycocyanobilin in a coordinated complex with an iron ion. In some preferred embodiments, the iron ion is an Fe²⁺ ion. In some preferred embodiments, the phycocyanobilin is Spirulina phycocyanobilin. In some preferred embodiments, the compound has a molar mass of approximately 641.535 amu. In some preferred embodiments, the compound is soluble in a solvent selected from the group consisting of methanol and water. In some preferred embodiments, a solution of the compound in water or methanol has a reddish brown color. In some preferred embodiments, a dried powder of the compound has a reddish brown color.

In some preferred embodiments, the present invention provides a composition comprising iron-complexed phycocyanobilin compounds at concentration of from 0.01% to 99.9% w/w of the composition, wherein w/w is weight of the iron-complexed phycocyanobilin divided by the total weight of the composition. In some preferred embodiments, the composition comprises 0.1% to 50% w/w of the iron-complexed phycocyanobilin compounds. In some preferred embodiments, the composition comprises 0.1% to 20% w/w of the iron-complexed phycocyanobilin compounds. In some preferred embodiments, the composition comprises 0.1% to 10% w/w of the iron-complexed phycocyanobilin compounds. In some preferred embodiments, the composition comprises 0.1% to 5% w/w of the iron-complexed phycocyanobilin compounds. In some preferred embodiments, the iron-complexed phycocyanobilin compounds comprise tetrapyrrole phycocyanobilin in a coordinated complex with an iron ion. In some preferred embodiments, the iron ion is an Fe²⁺ ion. In some preferred embodiments, the phycocyanobilin is Spirulina phycocyanobilin. In some preferred embodiments, the iron-complexed phycocyanobilin compound has a molar mass of approximately 641.535 amu. In some preferred embodiments, the iron-complexed phycocyanobilin compound is soluble in a solvent selected from the group consisting of methanol and water. In some preferred embodiments, a solution of the iron-complexed phycocyanobilin compounds in water or methanol has a reddish brown color. In some preferred embodiments, a dried powder of the composition has a reddish brown color. In some preferred embodiments, the composition has a meaty odor. In some preferred embodiments, the composition has an earthy odor.

In some preferred embodiments, the composition comprises a protein from a source other than Spirulina. In some preferred embodiments, the compositions further comprise a plant protein. In some preferred embodiments, the plant protein is selected from the group consisting of proteins from grains, oil seeds, leafy greens, biomass crops, root vegetables, and legumes. In some preferred embodiments, the grains are selected from the group consisting of corn, maize, rice, wheat, barley, rye, triticale and teff. In some preferred embodiments, the oilseeds are selected from the group consisting of cottonseed, sunflower seed, safflower seed, and rapeseed. In some preferred embodiments, the leafy greens are selected from the group consisting of lettuce, spinach, kale, collard greens, turnip greens, chard, mustard greens, dandelion greens, broccoli, and cabbage. In some preferred embodiments, the biomass crops are selected from the group consisting of switchgrass, miscanthus, sorghum, alfalfa, corn stover, green matter, sugar cane leaves and leaves of trees. In some preferred embodiments, the root crops are selected from the group consisting of cassava, sweet potato, potato, carrots, beets, and tumips. In some preferred embodiments, the legumes are selected from the group consisting of clover, cowpeas, English peas, yellow peas, green peas, soybeans, fava beans, lima beans, kidney beans, garbanzo beans, mung beans, pinto beans, lentils, lupins, mesquite, carob, soy, and peanuts, vetch (vicia), stylo (stylosanthes), arachas, indigofera, acacia, leucaena, eyamopsis, and seshama.

In some preferred embodiments, the compositions further comprise a fat from a source other than Spirulina. In some preferred embodiments, the fat is selected from the group consisting of corn oil, olive oil, soy oil, peanut oil, walnut oil, almond oil, sesame oil, cottonseed oil, rapeseed oil, canola oil, safflower oil, sunflower oil, flax seed oil, algal oil, palm oil, palm kernel oil, coconut oil, babassu oil, shea butter, mango butter, cocoa butter, wheat germ oil, rice bran oil, an oil produced by bacteria, an oil produced by archaea, an oil produced by fungi, an oil produced by genetically engineered bacteria, an oil produced by genetically engineered algae, an oil produced by genetically engineered archaea, and an oil produced by genetically engineered fungi, and a mixture of two or more thereof.

In some preferred embodiments, the compositions are further characterized in comprising between 10-30% w/w protein, between 5-80% w/w water, and between 5-70% fat. In some preferred embodiments, the present invention provides a food product containing a compound or a composition as described above.

In some preferred embodiments, the present invention provides a multi-component food product comprising: a first component comprising iron-complexed phycocyanobilin compounds at concentration of from 0.01% to 99.9% w/w of the composition, wherein w/w is weight of the iron-complexed phycocyanobilin divided by the total weight of the first component: a second component comprising a non-animal protein from a source other than Spirulina.

In some preferred embodiments, the first component comprises 0.1% to 50% w/w of the iron-complexed phycocyanobilin compounds. In some preferred embodiments, the first component comprises 0.1% to 20% w/w of the iron-complexed phycocyanobilin compounds. In some preferred embodiments, the first component comprises 0.1% to 10% w/w of the iron-complexed phycocyanobilin compounds. In some preferred embodiments, the first component comprises 0.1% to 5% w/w of the iron-complexed phycocyanobilin compounds. In some preferred embodiments, the iron-complexed phycocyanobilin compounds in the first component comprise tetrapyrrole phycocyanobilin in a coordinated complex with an iron ion. In some preferred embodiments, the iron ion is an Fe²⁺ ion. In some preferred embodiments, the phycocyanobilin is Spirulina phycocyanobilin. In some preferred embodiments, the iron-complexed phycocyanobilin compound has a molar mass of approximately 641.535 amu.

In some preferred embodiments, the second component comprising a non-animal protein from a source other than Spirulina is a plant protein. In some preferred embodiments, the plant protein is selected from the group consisting of proteins from grains, oil seeds, leafy greens, biomass crops, root vegetables, and legumes. In some preferred embodiments, the grains are selected from the group consisting of corn, maize, rice, wheat, barley, rye, triticale and teff. In some preferred embodiments, the oilseeds are selected from the group consisting of cottonseed, sunflower seed, safflower seed, and rapeseed. In some preferred embodiments, the leafy greens are selected from the group consisting of lettuce, spinach, kale, collard greens, tumip greens, chard, mustard greens, dandelion greens, broccoli, and cabbage. In some preferred embodiments, the biomass crops are selected from the group consisting of switchgrass, miscanthus, sorghum, alfalfa, corn stover, green matter, sugar cane leaves and leaves of trees. In some preferred embodiments, the root crops are selected from the group consisting of cassava, sweet potato, potato, carrots, beets, and turnips. In some preferred embodiments, the legumes are selected from the group consisting of clover, cowpeas, English peas, yellow peas, green peas, soybeans, fava beans, lima beans, kidney beans, garbanzo beans, mung beans, pinto beans, lentils, lupins, mesquite, carob, soy, and peanuts, vetch (vicia), stylo (stylosanthes), arachis, indigofera, acacia, leucacna, evamopsis, and seshania.

In some preferred embodiments, the compositions further comprise a third component comprising a fat from a source other than Spirulina. In some preferred embodiments, the fat is selected from the group consisting of corn oil, olive oil, soy oil, peanut oil, walnut oil, almond oil, sesame oil, cottonseed oil, rapeseed oil, canola oil, safflower oil, sunflower oil, flax seed oil, algal oil, palm oil, palm kernel oil, coconut oil, babassu oil, shea butter, mango butter, cocoa butter, wheat germ oil, rice bran oil, an oil produced by bacteria, an oil produced by archaea, an oil produced by fungi, an oil produced by genetically engineered bacteria, an oil produced by genetically engineered algae, an oil produced by genetically engineered archaea, and an oil produced by genetically engineered fungi, and a mixture of two or more thereof.

In some preferred embodiments, the multicomponent food product is further characterized in comprising between 10-30% w/w total protein, between 5-80% w/w water, and between 5-70% fat.

In some preferred embodiments, the present invention provides methods comprising: providing a composition comprising phycocyanobilin; and reacting the composition with an iron ion donor compounds to provide a phycocyanobilin compound in a coordinated complex with an iron ion. In some preferred embodiments, the iron ion is Fe²⁺. In some preferred embodiments, the iron ion donor compound is selected from the group consisting of H₂Fe(CO)₄, Na₂Fe(CO)₄, Fe(CO)₅, Fe₂(CO)₉, Fe₃(CO)₁₂, Fe(CO)₃CH₃COC₂H₂C₆H₆, FeH, Fe3C, FeBr₂, FeCl₂, FeF₂, FeI₂, FeH₂, FeMoO₄, FeO, Fe(OH)₂, FeS, FeSO₄, FeSe, FeSeO₄, FeSi₂, FeTiO₃, FeCO₃, FeC₂O₄, Fe(C₂H₃O₂)₂, Fe(C₃H₅O₃)₂, FeC₆H₆O₇, FeC₁₂H22O₁₄, FeCr₂O₄, Fe₃(PO₄)₂, Fe(HCO₃)₂, Mg₂FeH₆, Fe(C₅H₅)₂, Fe(C₅H₄P(C₆H₅)₂)₂, C₄H₄Fe(CO)₃, C₄H₆Fe(CO)₃, Fe₃P, Fe₃O₄, Fe₃S₄, FeBr₃, FeCl₃, FeF₃, FeI₃, Fe(NO₃)₃, Tris (acetylacetonato) iron (III), FeOCl, FeO(OH), FePO₄, Fe₄(P₂O₇)₃, Fe₂(CrO₄)₃, Fe₂(C₂O₄)₃, Fe₂O₃, Fe₂S₃, Fe₂(SO₄)₃, FeBO₃, FeB, Fe(C₅H₅)₂BF₄, FeSi, FeGe, K₂FeO₄, and BaFeO₄. In some preferred embodiments, the composition comprising phycocyanobilin is a phycobiliprotein (PBP) composition.

In some preferred embodiments, the PBP composition is characterized by one or more of the following characteristics:
a) the protein fraction of the composition comprises greater than about 30% of a protein having a molecular weight of about 17,695 kDa and an isoelectric point of about 6.29 as assayed by two dimensional gel electrophoresis followed by quantitation by densitometry;
b) the protein fraction of the composition comprises greater than about 5% of a protein having a molecular weight of about 19,833 kDa and an isoelectric point of about 6.14 as assayed by two dimensional gel electrophoresis followed by quantitation by densitometry;
c) the protein fraction of the composition comprises greater than about 1% of a protein having a molecular weight of about 45,578 kDa and an isoelectric point of about 6.2 as assayed by two dimensional gel electrophoresis followed by quantitation by densitometry;
d) the protein fraction of the composition comprises greater than about 1% of a protein having a molecular weight of about 35,014 kDa and an isoelectric point of about 5.9 as assayed by two dimensional gel electrophoresis followed by quantitation by densitometry;
e) the protein fraction of the composition comprises greater than about 0.30% of a protein having a molecular weight of about 24,688 kDa and an isoelectric point of about 5.3 as assayed by two dimensional gel electrophoresis followed by quantitation by densitometry;
f) the protein fraction of the composition comprises greater than about 2% of a protein having a molecular weight of about 22,522 kDa and an isoelectric point of about 5.9 as assayed by two dimensional gel electrophoresis followed by quantitation by densitometry;
g) the protein fraction of the composition comprises greater than about 1% of a protein having a molecular weight of about 21,023 kDa and an isoelectric point of about 7.3 as assayed by two dimensional gel electrophoresis followed by quantitation by densitometry;
h) the protein fraction of the composition comprises greater than about 0.50% of a protein having a molecular weight of about 13,417 kDa and an isoelectric point of about 7.3 as assayed by two dimensional gel electrophoresis followed by quantitation by densitometry;
i) the protein fraction of the composition comprises a ratio of major protein constituents to minor protein constituents of less than 3.5:1 based on the aggregate mass of the proteins, wherein major protein constituents are the protein having a molecular weight of about 17,695 kDa and an isoelectric point of about 6.29 as assayed by two dimensional gel electrophoresis followed by quantitation by densitometry and the protein having a molecular weight of about 19,833 kDa and an isoelectric point of about 6.14 as assayed by two dimensional gel electrophoresis followed by quantitation by densitometry and the minor protein constituents are the remainder of the proteins;
j) the protein fraction of the composition comprises less than about 75% on a mass basis of the combined amounts of the protein having a molecular weight of about 17,695 kDa and an isoelectric point of about 6.29 as assayed by two dimensional gel electrophoresis followed by quantitation by densitometry and the protein having a molecular weight of about 19,833 kDa and an isoelectric point of about 6.14 as assayed by two dimensional gel electrophoresis followed by quantitation by densitometry;
k) the composition produces a solution having a color value of greater than 200 E 10%/1 cm when 250 mg of a dry powder of the composition are dissolved in one liter of water and absorbance is measured at 618 nm.

In some preferred embodiments, the composition comprising phycocyanobilin is produced by: encapsulating Spirulina to provide capsules: and contacting the capsules with an aqueous medium under conditions such that PCB containing PBP passes from the capsule into the aqueous solution. In some preferred embodiments, the step of encapsulating Spirulina to provide capsules comprises: mixing dried or fresh Spirulina with water and multivalent cations to provide a first solution: and forming the capsules by dropping the first solution into a second solution comprising a gelling agent.

In some preferred embodiments, the methods further comprise formulating a food product by combining the phycocyanobilin compound in a coordinated complex with an iron ion with a protein composition that is not obtained from Spirulina. In some preferred embodiments, the methods further comprise combining the phycocyanobilin compound in a coordinated complex with an iron ion and the protein composition that is not obtained from Spirulina with a fat that is not obtained from Spirulina.

In some preferred embodiments, the present invention provides methods of making a food product comprising: providing a first component comprising iron-complexed phycocyanobilin compounds at concentration of from 0.01% to 99.9% w/w of the composition, wherein w/w is weight of the iron-complexed phycocyanobilin divided by the total weight of the first component and a second component comprising a non-animal protein from a source other than Spirulina; and forming the first component and the second component into a food product. In some preferred embodiments, the methods further comprise providing a third component comprising a fat from a source other than Spirulina and forming the first, second and third components into a food product.

### DETAILED DESCRIPTION OF THE INVENTION

In the body, the “heme” protein constitutes one component of hemoglobin and serves to carry oxygen from the lungs throughout the body by binding to it. Its structure is that of a ligand, featuring an iron ion bound to a heterocyclic organic compound known as a tetrapyrrole. In the context of human consumption, heme is believed to be the reason for one aspect of meat's characteristic taste by virtue of the presence of the iron ion imparting a “metallic” taste.

The present invention provides non-animal based structural analogs of heme comprising iron-complexed phycocyanobilin (PCB) compounds for use in food products including plant-based meat alternatives which successfully replicate the taste of meat. The description of the compound herein encompasses any formulations of iron-complexed phycocyanobilin (PCB) compounds in dietary or food product. In some preferred embodiments, the invention provides plant-based foodstuffs which imitate the taste, texture, aroma, and overall experience of eating meat. It will be understood that the iron-complexed phycocyanobilin (PCB) compounds mimic the structure and certain properties of the heme molecule. The compound's algal origin makes it viable for use in settings where animal-based products cannot be.

### 1. Sources of PCB

In preferred embodiments, phycobiliprotein (PBP, preferably phycocyanin (PC)) compositions comprising phycocyanobilin (PCB) are obtained via methods described in PCT Appl. PCT/US2019/061709 which is incorporated by reference herein its entirety, and used to produce the iron-complexed phycocyanobilin (PCB) compounds of the present invention as described in Section 2 below and in the examples.

The PBP purification processes are based on a chemical reaction between a gelling agent and a multivalent cation. Exposing the gelling agent to the multivalent cation (or vice versa) facilitates the formation of a gel and/or a membrane, trapping the cellular debris and other large-size molecular assemblies, but allowing diffusion of water-soluble small molecules and proteins into the surrounding aqueous medium, usually water, thereby permitting the purification of the desired substance such as PBP (phycobiliprotein, preferably phycocyanin (PC)) which comprises the linear tetrapyrrole PCB. The multivalent cation may also act on the cell wall of, for example Spirulina, thereby making it more fragile and porous and consequently allowing the extracellular diffusion of PBP and other water-soluble molecules. Thus, the methods of the present invention result not only in the purification of, for example PBP comprising PCB but also permit the extraction of PBP and thus PCB from Spirulina in an aqueous solution in a single step.

In some preferred embodiments, the processes to prepare purified PCB from Spirulina comprises the following steps:
Mixing dried or fresh Spirulina, water and a gelling agent, for example sodium alginate to provide a first solution (Solution A)
Forming microcapsules by dropping small drops of Solution A using a dropper, pipette or some other industrial device or machine into a second solution of a salt of divalent cations.
Diluting the microcapsules into a predetermined volume of water or other liquid to provide an aqueous solution to permit purification through diffusion of the PBP from the microcapsules
Removal of the microcapsules and any debris from the liquid

In some preferred embodiments, the processes to prepare purified PBP from Spirulina comprises the following steps:
Mixing dried or fresh Spirulina, water and divalent cation, for example calcium chloride to provide a first solution (Solution A)
Forming microcapsules by dropping small drops of Solution A using a dropper, pipette or some other industrial device or machine into a second solution of a gelling agent, such as sodium alginate.
Diluting the microcapsules into a predetermined volume of water or other liquid to provide an aqueous solution to permit purification through diffusion of the PBP from the microcapsules
Removal of the microcapsules and any debris from the liquid

In some preferred embodiments, the processes to prepare purified PBP from Spirulina comprises the following steps:
Mixing dried or fresh Spirulina with water
Transforming the Spirulina and water mixture into a droplet, extruded tube or sausage or some other form
Coating this droplet, extruded tube or sausage or some other form with a layer of a solution of gelling agent such as sodium alginate
Coating the droplet, extruded tube or sausage or some other form that has been coated with the gelling agent, with a salt of divalent cations.
Placing the droplets, extruded tubes or sausages or some other forms that have been coated with the gelling agent and thereafter the divalent cation solution into a predetermined volume of water or other liquid to provide an aqueous solution to permit purification through diffusion of the PBP.
Removal of the droplets, extruded tubes or sausages or some other form and any debris from the liquid.

In some preferred embodiments, the different methods previously described to produce the purified PBP compositions can be used simultaneously, sequentially or repeatedly.

In some preferred embodiments, the PBP containing organism biomass is specially prepared through heat, cold, chemical and biological processes and physical mechanisms and techniques to facilitate the purification process of this invention.

In some preferred embodiments, the PBP composition comprises a dried powder comprising a purified PBP composition as described above, the powder having a residual moisture content of less than about 10% w/w of the powder.

In some preferred embodiments, the PBP composition comprises fresh or freshly harvested PBP containing organism biomass.

In some preferred embodiments, the microcapsule or other form contains chemicals or biological agents that enhance or retard or selectively control the purification of the PBP.

In some preferred embodiments, the microcapsule or other form contains a natural substance that is purified or concentrated in conjunction with or ‘chaperoned’ into the aqueous solution by the PBP or some other substance that exists in the organism biomass.

In some preferred embodiments the aqueous solution into which the PBP diffuses is modified by changing its temperature, through agitation or mixing or the addition of chemical or biological agents such as acids, alkalis, salts and antimicrobial agents to enhance or retard diffusion of PBP and to prevent contamination.

In some preferred embodiments, the microcapsule or other form is frozen, dried or treated in some other way to enhance or retard diffusion of the PBP into the aqueous solution

In some preferred embodiments, the biomass used is the genus Arthrospira, and more preferably to the species Arthrospira platensis (commonly known as Spirulina). In some preferred embodiments, the gelling agent is sodium alginate which reacts with most multivalent cations and especially well with the calcium ions. Preferred sources of calcium ions are, for example, calcium chloride and calcium gluconate. The present invention is not limited to the use of calcium ions. In other embodiments, the multivalent cations may be provided by salts of manganese, magnesium, zinc, or barium.

In some preferred embodiments, the first solution is prepared with 10% to 60% Spirulina (wet weight), 0.1% to 5% sodium alginate (dry weight) and water. Several additives can be added to the solution including flavorings, color agents, preservatives, moisteners, natural antibiotics, thickeners, sugars, anti-foaming agents, salts, acids and alkalis.

In some preferred embodiments, the second solution is an aqueous solution containing multivalent cations at a concentration between 0.005 and 0.5 mole per liter, preferably between 0).05 and 0.2 mole per liter (corresponding for example to the range 5.5-22 g/L of calcium chloride). This solution can also contain flavorings, color additives, preservatives and acidifying agents.

The present invention is not limited to any particular mechanism of action. Indeed, an understanding of the mechanism of action is not necessary to practice the invention. Nevertheless, it is contemplated that the microcapsules generated by dropping the first solution into the second solution are irregular, roughly egg-shaped with a maximum dimension of less than 6 mm and have a solid texture. Other forms can include tubular or spaghetti-like shapes, sausages, disks and irregular shapes. The setting time, during which the microcapsules or other forms are immersed in the solution B, is preferably less than 1 hour.

The purification of the preferably takes place as the last step of the process. Specifically, the microcapsules are immersed in a large volume of water and the medium containing the microcapsules is kept at a low temperature (between 0) and 6° C.) for from about 1 to 60 hours. The diffusion of the purified PBP can demonstrated when the water become progressively bluer and shows a purple fluorescence when exposed to light. These observed phenomena as characteristic of the PBP complex of Spirulina.

In preferred embodiments, the microcapsules or other forms may be manufactured in a workshop or a factory and the extraction is undertaken at a consumer's home or at an industrial site or on a farm or in a laboratory.

In some preferred embodiments, microcapsules are packaged into a porous container such as a bag, a sachet, a pod or the like, with a pore size much lower than the microcapsule size to ensure that PBP can diffuse while the microcapsules remain in the container. In some preferred embodiments, the process steps are conducted at low temperatures (e.g., between 0 and 6° C.) to prevent PBP degradation or natural or chemical preservatives are added.

The process of purification described in this invention has a number of advantages over existing algal biomass purification methods. The main advantage is that it is possible to limit or even avoid the use of membrane-based filtration in the production of purified algal extracts such as PC, thereby substantially reducing the cost of production and improving the quality of such extracts. The process described also does not require the use of salts and other substances to precipitate out the PC and the consequent expense of dialysis, osmosis, gels and exchange columns to remove such salts. This invention also can increase the yield of PBP extraction and the concentration of proteins of interest in the purified extract. This invention permits the combination of extraction and purification in a single step, if desired. As a result, it is possible to make purified extract of Spirulina with very high PC concentrations. This invention permits purification of PBP without using chemical solvents or any product from animal origin, allowing the making of an PC-rich extract compatible with vegan, halal and kosher food requirements. This invention is not damaging to delicate and sensitive proteins and other molecules including PBP thereby permitting the purification of highly active natural extracts. This invention permits low-waste, low water consumption purification with positive impacts in terms of sustainability and compatibility with circular economy principles. This invention can be applied to a wide range of algae and other natural substances. This invention is easily scalable with fairly low capital expenditure costs on machinery and technologies.

In some preferred embodiments, the processes provide microcapsules or other forms with the following characteristics: suitable for an aqueous medium, containing as dry weight, between 1 and 20 percent of gelling agent, between 1 and 20 percent of a multivalent cations salt and between 60 and 98 percent of MP, containing at least 5 percent of PBP able to diffuse freely in the aqueous medium.

The methods described herein are useful for producing compositions containing a high quality protein fraction that is enriched for PBP and thus PCB. The protein content and quality of the PBP purified extracts obtained by these methods differ substantially from other described PBP purified extracts, generally purified using membrane filtration methods, as demonstrated in the Examples.

Accordingly, in some preferred embodiments, the present invention provides purified PBP protein compositions characterized by one or more of the following characteristics;
a) the protein fraction of the composition comprises greater than about 30% of a protein having a molecular weight of about 17,695 kDa and an isoelectric point of about 6.29 as assayed by two dimensional gel electrophoresis followed by quantitation by densitometry;
b) the protein fraction of the composition comprises greater than about 5% of a protein having a molecular weight of about 19,833 kDa and an isoelectric point of about 6.14 as assayed by two dimensional gel electrophoresis followed by quantitation by densitometry;
c) the protein fraction of the composition comprises greater than about 1% of a protein having a molecular weight of about 45,578 kDa and an isoelectric point of about 6.2 as assayed by two dimensional gel electrophoresis followed by quantitation by densitometry;
d) the protein fraction of the composition comprises greater than about 1% of a protein having a molecular weight of about 35,014 kDa and an isoelectric point of about 5.9 as assayed by two dimensional gel electrophoresis followed by quantitation by densitometry;
e) the protein fraction of the composition comprises greater than about 0.30% of a protein having a molecular weight of about 24,688 kDa and an isoelectric point of about 5.3 as assayed by two dimensional gel electrophoresis followed by quantitation by densitometry;
f) the protein fraction of the composition comprises greater than about 2% of a protein having a molecular weight of about 22,522 kDa and an isoelectric point of about 5.9 as assayed by two dimensional gel electrophoresis followed by quantitation by densitometry;
g) the protein fraction of the composition comprises greater than about 1% of a protein having a molecular weight of about 21,023 kDa and an isoelectric point of about 7.3 as assayed by two dimensional gel electrophoresis followed by quantitation by densitometry;
h) the protein fraction of the composition comprises greater than about 0.50% of a protein having a molecular weight of about 13,417 kDa and an isoelectric point of about 7.3 as assayed by two dimensional gel electrophoresis followed by quantitation by densitometry;
i) the protein fraction of the composition comprises a ratio of major protein constituents to minor protein constituents of less than 3.5:1 based on the aggregate mass of the proteins, wherein major protein constituents are the protein having a molecular weight of about 17,695 kDa and an isoelectric point of about 6.29 as assayed by two dimensional gel electrophoresis followed by quantitation by densitometry and the protein having a molecular weight of about 19,833 kDa and an isoelectric point of about 6.14 as assayed by two dimensional gel electrophoresis followed by quantitation by densitometry and the minor protein constituents are the remainder of the proteins;
j) the protein fraction of the composition comprises less than about 75% on a mass basis of the combined amounts of the protein having a molecular weight of about 17,695 kDa and an isoelectric point of about 6.29 as assayed by two dimensional gel electrophoresis followed by quantitation by densitometry and the protein having a molecular weight of about 19,833 kDa and an isoelectric point of about 6.14 as assayed by two dimensional gel electrophoresis followed by quantitation by densitometry; and
k) the composition produces a solution having a color value of greater than 180 E 10%/1 cm when 250 mg of a dry powder of the composition are dissolved in one liter of water and absorbance is measured at 618 nm.

In some preferred embodiments, the composition has at least two of characteristics a, b, c, d, e, f, g, h, i, j and k. In some preferred embodiments, the composition has at least three of characteristics a, b, c, d, e, f, g, h, i, j and k. In some preferred embodiments, the composition has at least four of characteristics a, b, c, d, e, f, g, h, i, j and k. In some preferred embodiments, the composition has at least five of characteristics a, b, c, d, e, f, g, h, i, j and k. In some preferred embodiments, the composition has at least six of characteristics a, b, c, d, e, f, g, h, i, j and k. In some preferred embodiments, the composition has at least seven of characteristics a, b, c, d, e, f, g, h, i, j and k. In some preferred embodiments, the composition has at least eight of characteristics a, b, c, d, e, f, g, h, i, j and k. In some preferred embodiments, the composition has at least nine of characteristics a, b, c, d, e, f, g, h, i, j and k. In some preferred embodiments, the composition has at least ten of characteristics a, b, c, d, e, f, g, h, i, j and k. In some preferred embodiments, the composition has all eleven characteristics a, b, c, d, e, f, g, h, i, j and k. It will be understood by those of skill in the art that in preferred embodiments, the compositions of the present invention may be identified by any subcombination of one or more of the characteristics identified above.

In some preferred embodiments, the purified phycobiliprotein composition is produced by a process comprising: mixing PBP containing organism biomass with water and gelling agent, forming a droplet, introducing a droplet of the first solution into a second solution containing a salt of divalent cations under conditions such that microcapsules form, and obtaining an extract enriched for PBP by mixing the microcapsules with a volume of an aqueous solution under conditions such that the phycobiliprotein diffuses from the microcapsules into the aqueous solution.

In some preferred embodiments, the purified PBP composition is produced by a process comprising: mixing PBP containing organism biomass with water and a salt of divalent cations, forming a droplet, introducing a droplet of the first solution into a second solution containing a gelling agent under conditions that microcapsules form, and obtaining an extract enriched for PBP by mixing the microcapsules with a volume of an aqueous solution under conditions such that the PBP diffuses from the microcapsules into the aqueous solution.

### 2. Production of Iron-Complexed PCB

In preferred embodiments, the PBP composition described above, or PCB purified from the PBP composition, is reacted with an iron ion donor to provide iron-complexed PCB compounds and compositions. Detailed methods are provided in the Example section below. In some preferred embodiments, reaction of the iron ion donor with a PBP composition or purified PCB provides a linear polycyclic tetrapyrrole molecules consisting of a PCB molecule in a coordination complex with an Fe²⁺ ion which is herein referred to as an “iron-complexed PCB compound.” Suitable ion donor compounds include, but are not limited to, H₂Fe(CO)₄, Na₂Fe(CO)₄, Fe(CO)₅, Fe₂(CO)₉, Fe₃(CO)₁₂, Fe(CO)₃CH₃COC₂H₂C₆H₆, FeH, Fe3C, FeBr₂, FeCl₂, FeF₂, FeI₂, FeH₂, FeMoO₄, FeO, Fe(OH)₂, FeS, FeSO₄, FeSe, FeSeO₄, FeSi₂, FeTiO₃, FeCO₃, FeC₂O₄, Fe(C₂H₃O₂)₂, Fe(C₃H₅O₃)₂, FeC₆H₆O₇, FeC₁₂H₂₂O₁₄, FeCr₂O₄, Fe₃(PO₄)₂, Fe(HCO₃)₂, Mg₂FeH₆, Fe(C₅H₅)₂, Fe(C₅H₄P (C₆H₅)₂)₂, C₄H₄Fe(CO)₃, C₄H₆Fe(CO)₃, Fe₃P, Fe₃O₄, Fe₃S₄, FeBr₃, FeCl₃, FeF₃, FeI₃, Fe(NO₃)₃, Tris(acetylacetonato) iron (III), FeOCl, FeO(OH), FePO₄, Fe₄(P₂O₇)₃, Fe₂(CrO₄)₃, Fe₂(C₂O₄)₃, Fe₂O₃, Fe₂S₃, Fe₂(SO₄)₃, FeBO₃, FeB, Fe (C₅H₅)₂BF₄, FeSi, FeGe, K₂FeO₄, and BaFeO₄.

The iron-complexed PCB compounds produced by the methods of the present invention have a molecule mass of approximately 641.535 amu (i.e., 641.535 +10 amu). The iron-complexed PCB compounds and compositions of the present invention are preferably soluble in protic or aqueous solvents including, but not limited to methanol and water. Solutions of the iron-complexed PCB compounds in methanol or water are characterized in having a reddish brown color. Likewise, dried powders comprising the iron-complexed PCB compounds have a reddish brown color. Furthermore, dried powders comprising the iron-complexed PCB compounds are characterized in having a meaty and/or earthy odor.

In some preferred embodiments, the methods provide an iron-complexed PCB composition that comprises the iron-complexed PCB compounds in association with PBP and/or other proteins present in the PBP composition produced by the methods described above.

In some preferred embodiments, the compositions comprise iron-complexed phycocyanobilin compounds at concentration of from 0.01% to 99.9% w/w of the composition, wherein w/w is weight of the iron-complexed phycocyanobilin divided by the total weight of the composition.

In some preferred embodiments, the compositions comprise 0.01% to 50% w/w of the iron-complexed phycocyanobilin compounds. In some preferred embodiments, the compositions comprise 0.01% to 20% w/w of the iron-complexed phycocyanobilin compounds. In some preferred embodiments, the compositions comprise 0.01% to 10% w/w of the iron-complexed phycocyanobilin compounds. In some preferred embodiments, the compositions comprise 0.01% to 5% w/w of the iron-complexed phycocyanobilin compounds.

In some preferred embodiments, the compositions comprise 0).1% to 50% w/w of the iron-complexed phycocyanobilin compounds. In some preferred embodiments, the compositions comprise 0).1% to 20% w/w of the iron-complexed phycocyanobilin compounds. In some preferred embodiments, the compositions comprise 0.1% to 10% w/w of the iron-complexed phycocyanobilin compounds. In some preferred embodiments, the compositions comprise 0).1% to 5% w/w of the iron-complexed phycocyanobilin compounds.

In some preferred embodiments, the compositions comprise 0.5% to 50% w/w of the iron-complexed phycocyanobilin compounds. In some preferred embodiments, the compositions comprise 0.5% to 20% w/w of the iron-complexed phycocyanobilin compounds. In some preferred embodiments, the compositions comprise 0.5% to 10% w/w of the iron-complexed phycocyanobilin compounds. In some preferred embodiments, the compositions comprise 0).5% to 5% w/w of the iron-complexed phycocyanobilin compounds.

In some preferred embodiments, the compositions comprise 1.0% to 50% w/w of the iron-complexed phycocyanobilin compounds. In some preferred embodiments, the compositions comprise 1.0% to 20% w/w of the iron-complexed phycocyanobilin compounds. In some preferred embodiments, the compositions comprise 1.0% to 10% w/w of the iron-complexed phycocyanobilin compounds. In some preferred embodiments, the compositions comprise 1.0% to 5% w/w of the iron-complexed phycocyanobilin compounds.

### 3. Uses of Iron-Complexed PCB Compounds and Compositions

In preferred embodiments, the iron-complexed PCB compounds and compositions are utilized in food products.

In some preferred embodiments, the food products comprise iron-complexed phycocyanobilin compounds or compositions at concentration of from 0.01% to 99.9% w/w of the food product, wherein w/w is weight of the iron-complexed phycocyanobilin compounds or composition divided by the total weight of the food product.

In some preferred embodiments, the food products comprise 0.01% to 50% w/w of the iron-complexed phycocyanobilin compounds or compositions. In some preferred embodiments, the food products comprise 0.01% to 20% w/w of the iron-complexed phycocyanobilin compounds or compositions. In some preferred embodiments, the food products comprise 0.01% to 10% w/w of the iron-complexed phycocyanobilin compounds or compositions. In some preferred embodiments, the food products comprise 0.01% to 5% w/w of the iron-complexed phycocyanobilin compounds or compositions.

In some preferred embodiments, the food products comprise 0.1% to 50% w/w of the iron-complexed phycocyanobilin compounds or compositions. In some preferred embodiments, the food products comprise 0.1% to 20% w/w of the iron-complexed phycocyanobilin compounds or compositions. In some preferred embodiments, the food products comprise 0.1% to 10% w/w of the iron-complexed phycocyanobilin compounds or compositions. In some preferred embodiments, the food products comprise 0.1% to 5% w/w of the iron-complexed phycocyanobilin compounds or compositions.

In some preferred embodiments, the food products comprise 0.5% to 50% w/w of the iron-complexed phycocyanobilin compounds or compositions. In some preferred embodiments, the food products comprise 0.5% to 20% w/w of the iron-complexed phycocyanobilin compounds or compositions. In some preferred embodiments, the food products comprise 0.5% to 10% w/w of the iron-complexed phycocyanobilin compounds or compositions. In some preferred embodiments, the food products comprise 0.5% to 5% w/w of the iron-complexed phycocyanobilin compounds or compositions.

In some preferred embodiments, the food products comprise 1.0% to 50% w/w of the iron-complexed phycocyanobilin compounds or compositions. In some preferred embodiments, the food products comprise 1.0% to 20% w/w of the iron-complexed phycocyanobilin compounds or compositions. In some preferred embodiments, the food products comprise 1.0% to 10% w/w of the iron-complexed phycocyanobilin compounds or compositions. In some preferred embodiments, the food products comprise 1.0% to 5% w/w of the iron-complexed phycocyanobilin compounds or compositions.

In some preferred embodiments, the food products do not contain animal proteins or are free from animal proteins.

In some embodiments, the food products additionally comprise one or more isolated, purified proteins. In preferred embodiments, the additional proteins are not obtained or derived from Spirulina. In some embodiments, about 0 1%, 0.2%, 0.5%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95% or more of the protein component of a food product is comprised of the one or more additional isolated, purified proteins. For the purposes of this document, “purified protein” will refer to a preparation in which the cumulative abundance by mass of protein components other than the specified protein, which can be a single monomeric or multimeric protein species, is reduced by a factor of 2 or more, 3 or more, 5 or more, 10 or more, 20 or more, 50 or more, 100 or more or 1000 or more relative to the source material from which the specified protein was isolated.

The additional protein in the food product can come from a variety or combination of sources Non-animal sources can provide some or all of the protein in the food product. Non-animal sources can include vegetables, fruits, nuts, grains, algae, bacteria, or fungi. The protein can be isolated or concentrated from one or more of these sources. In some embodiments the food product is a meat replica comprising protein only obtained from non-animal sources.

In some embodiments, the one or more isolated, purified proteins are derived from non-animal sources. Non-limiting examples of non-animal sources include plants, fungi, bacteria, archaea, genetically modified organisms such as genetically modified bacteria or yeast, chemical or in vitro synthesis. In particular embodiments, the one or more isolated, purified proteins are derived from plant sources. Non-limiting examples of plant sources include grains such as, e.g., corn, maize, rice, wheat, barley, rye, triticale, teff, oilseeds including cottonseed, sunflower seed, safflower seed, rapeseed, leafy greens such as, e.g., lettuce, spinach, kale, collard greens, turnip greens, chard, mustard greens, dandelion greens, broccoli, cabbage, green matter not ordinarily consumed by humans, including biomass crops, including switchgrass, miscanthus, sorghum, other grasses, alfalfa, corn stover, green matter ordinarily discarded from harvested plants, sugar cane leaves, leaves of trees, root crops such as cassava, sweet potato, potato, carrots, beets, turnips, plants from the legume family, such as, e.g., clover, peas such as cowpeas, English peas, yellow peas, green peas, beans such as, e.g., soybeans, fava beans, lima beans, kidney beans, garbanzo beans, mung beans, pinto beans, lentils, lupins, mesquite, carob, soy, and peanuts, vetch (vicia), stylo (stylosanthes), arachis, indigofera, acacia, leucaena, cyamopsis, and sesbania. One of skill in the art will understand that proteins that can be isolated from any organism in the plant kingdom may be used in the present invention.

Proteins that are abundant in plants can be isolated in large quantities from one or more source plants and thus are an economical choice for use in food products of the instant invention. Accordingly, in some embodiments, the one or more isolated proteins comprises an abundant protein found in high levels in a plant and capable of being isolated and purified in large quantities. In some embodiments, the abundant protein comprises about 0.5%, 1%, 2%, 3%, 4%. 5%, 6%, 7%, 8%, 9%. 10%, 15%, 20%, 25%, 30%, 35%, 40%, 45%, 50%, 55%, 60%, 65%, 70% of the total protein content of the source plant. In some embodiments, the abundant protein comprises about 0.5-10%, about 5-40%, about 10-50%, about 20-60%, or about 30-70% of the total protein content of the source plant. In some embodiments, the abundant protein comprises about 0.5%, 1%. 2%, 3%, 4%, 5%, 6%, 7%, 8%, 9%, 10%, 15%, 20%, 25%, 30%, 35%, 40%, 45%, 50% of the total weight of the dry matter of the source plant. In some embodiments, the abundant protein comprises about 0.5-5%, about 1-10%, about 5-20%, about 10-30%, about 15-40%, about 20-50% of the total weight of the dry matter of the source plant.

In particular embodiments, the one or more isolated proteins comprises an abundant protein that is found in high levels in the leaves of plants. In some embodiments, the abundant protein comprises about 0.5%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80% of the total protein content of the leaves of the source plant. In some embodiments, the abundant protein comprises about 0.5-10%, about 5%- 40%, about 10%- 60%, about 20%- 60%, or about 30-70% of the total protein content of the leaves of the source plant. In particular embodiments, the one or more isolated proteins comprise ribulose-1,5-bisphosphate carboxylase oxygenase (rubisco activase). Rubisco is a particularly useful protein for food products because of its high solubility and an amino acid composition with close to the optimum proportions of essential amino acids for human nutrition. In particular embodiments, the one or more isolated proteins comprise ribulose-1 5-bisphosphate carboxylase oxygenase activase (rubisco activase). In particular embodiments, the one or more isolated proteins comprise a vegetative storage protein (VSP).

In some embodiments, the one or more isolated proteins include an abundant protein that is found in high levels in the seeds of plants. In some embodiments, the abundant protein comprises about 0.5%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85% or 90% or more of the total protein content of the seeds of the source plant. In some embodiments, the abundant protein comprises about 0.5-10%, about 5%- 40%, about 10%- 60%, about 20%- 60%, or about 30-70% or >70% of the total protein content of the seeds of the source plant. Non-limiting examples of proteins found in high levels in the seeds of plants are seed storage proteins, e.g., albumins, glycinins, conglycinins, globulins, vicilins, conalbumin, gliadin, glutelin, gluten, glutenin, hordein, prolamin, phaseolin (protein), proteinoplast, secalin, triticeae gluten, zein, any seed storage protein, oleosins, caloleosins, steroleosins or other oil body proteins.

In some embodiments, the protein component comprises the 8S globulin from Moong bean seeds, or the albumin or globulin fraction of pea seeds. These proteins provide examples of proteins with favorable properties for constructing meat replicas because of their ability to form gels with textures similar to animal muscle or fat tissue. Examples and embodiments of the one or more isolated, purified proteins are described herein. The list of potential candidates here is essentially open and may include Rubisco, any major seed storage proteins, proteins isolated from fungi, bacteria, archaea, viruses, or genetically engineered microorganisms, or synthesized in vitro. The proteins may be artificially designed to emulate physical properties of animal muscle tissue. The proteins may be artificially designed to emulate physical properties of animal muscle tissue. In some embodiments, one or more isolated, purified proteins accounts for about 0.1%, 0.2%, 0.5%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 99% or more of the protein component by weight.

In some embodiments, the food products additionally comprise an added fat. In preferred embodiments, the added fat is from a source other than Spirulina. In preferred embodiments, the added fat is from a non-animal source.

In some embodiments the fat content of the food product is 1%, 5%, 10%, 15%, 20%, 25%, 30%, 35%, 40%, 45%, 50%, 55%, or 60% fat. In some embodiments, the fat component comprises a gel with droplets of fat suspended therein. In some embodiments. the gel is a soft. elastic gel comprising proteins and optionally carbohydrates. In particular embodiments, the proteins used in the gel are plant or microbial proteins. In some embodiments, the proteins used in the fat component might include Rubisco, any major seed storage proteins, proteins isolated from fungi, bacteria, archaea, viruses, or genetically engineered microorganisms, or synthesized in vitro.

The fat droplets used in some embodiments of the present invention can be from a variety of sources. In some embodiments, the sources are non-animal sources. In particular embodiments, the sources are plant sources. Non-limiting examples of oils include corn oil, olive oil, soy oil, peanut oil, walnut oil, almond oil, sesame oil, cottonseed oil, rapeseed oil, canola oil, safflower oil, sunflower oil, flax seed oil, algal oil, palm oil, palm kernel oil, coconut oil, babassu oil, shea butter, mango butter, cocoa butter, wheat germ oil, rice bran oil, oils produced by bacteria, algae, archaea or fungi or genetically engineered bacteria, algae, archaea or fungi, triglycerides, monoglycerides, diglycerides, sphingosides, glycolipids, lecithin, lysolecithin, phophatidic acids, lysophosphatidic acids, oleic acid, palmitoleic acid, palmitic acid, myristic acid, lauric acid, myristoleic acid, caproic acid, capric acid, caprylic acid, pelargonic acid, undecanoic acid, linoleic acid, 20:1 eicosanoic acid, arachidonic acid, eicosapentanoic acid, docosohexanoic acid, 18:2 conjugated linoleic acid, conjugated oleic acid, or esters of oleic acid, palmitoleic acid, palmitic acid, myristic acid, lauric acid, myristoleic acid, caproic acid, capric acid, caprylic acid, pelargonic acid, undecanoic acid, linoleic acid, 20:1 eicosanoic acid, arachidonic acid, eicosapentanoic acid, docosohexanoic acid, 18:2 conjugated linoleic acid, or conjugated oleic acid, or glycerol esters of oleic acid, palmitoleic acid, palmitic acid, myristic acid, lauric acid, myristoleic acid, caproic acid, capric acid, caprylic acid, pelargonic acid, undecanoic acid, linoleic acid, 20:1 eicosanoic acid, arachidonic acid, eicosapentanoic acid, docosohexanoic acid, 18.2 conjugated linoleic acid, or conjugated oleic acid, or triglyceride derivatives of oleic acid, palmitoleic acid, palmitic acid, myristic acid, lauric acid, myristoleic acid, caproic acid, capric acid, caprylic acid, pelargonic acid, undecanoic acid, linoleic acid, 20:1 eicosanoic acid, arachidonic acid, eicosapentanoic acid, docosohexanoic acid, 18:2 conjugated linoleic acid, or conjugated oleic acid.

In some embodiments, fat droplets are derived from pulp or seed oil. In other embodiments, the source may be yeast or mold. For instance, in one embodiment the fat droplets comprise triglycerides derived from Mortierelia isabellina.

In some embodiments, the fat component comprises a protein component comprising one or more isolated, purified proteins. The purified proteins contribute to the taste and texture of the food product. In some embodiments purified proteins can stabilize emulsified fats In some embodiments the purified proteins can form gels upon denaturation or enzymatic crosslinking, which replicate the appearance and texture of animal fat. Examples and embodiments of the one or more isolated, purified proteins are described herein. In particular embodiments, the one or more isolated proteins comprise a protein isolated from the legume family of plants. Non-limiting examples of legume plants are described herein, although variations with other legumes are possible. In some embodiments, the legume plant is a pea plant. In some embodiments the isolated purified proteins stabilize emulsions. In some embodiments the isolated purified proteins form gels upon crosslinking or enzymatic crosslinking. In some embodiments, the isolated, purified proteins comprise seed storage proteins. In some embodiments, the isolated, purified proteins comprise albumin. In some embodiments, the isolated, purified proteins comprise globulin. In a particular embodiment, the isolated, purified protein is a purified pea albumin protein. In another particular embodiment, the isolated, purified protem is a purified pea globulin protein. In another particular embodiment the isolate purified protein is a Moong bean 8S globulin. In another particular embodiment, the isolated, purified protein is an oleosin. In another particular embodiment, the isolated, purified protein is a caloleosin. In another particular embodiment, the isolated, purified protein is Rubisco. In some embodiments, the protein component comprises about 0.1%, 0 5%, 1%, 2%, 5%, 10%, 15%, 20%, 25%, 30%, 35%, 40%, 45%, 50%, 55%, 60%, 65%, 70%, 75%, 80%, 85%, 90% or more of the fat component by dry weight or total weight. In some embodiments, the protein component comprises about 0.1-5%, about 0.5-10%, about 1-20%, about 5-30%, about 10-50%, about 20-70%, or about 30-90% or more of the fat component by dry weight or total weight. In some embodiments, the protein component comprises a solution containing one or more isolated, purified proteins.

In some embodiments, the fat component comprises cross-linking enzymes that catalyze reactions leading to covalent crosslinks between proteins. Cross-linking enzymes can be used to create or stabilize the desired structure and texture of the adipose tissue component, to mimic the desired texture of an equivalent desired animal fat. Non-limiting examples of cross-linking enzymes include, e.g, transglutaminase, lysyl oxidases, or other amine oxidases (e.g. Pichia pastoris lysyl oxidase). In some embodiments, the cross-linking enzymes are isolated and purified from a non-animal source, examples and embodiments of which are described herein. In some embodiments, the fat component comprises at least 0.0001%, or at least 0.001%, or at least 0.01%, or at least 0.1%, or at least 1% (wt/vol) of a cross-linking enzyme. In particular embodiments, the cross-linking enzyme is transglutaminase.

In some embodiments, the fat component is assembled to approximate the organization adipose tissue in meat In some embodiments some or all of the components of the fat component are suspended in a gel. In various embodiments the gel can be a proteinaceous gel, a hydrogel, an organogel, or a xerogel. In some embodiments, the gel can be thickened to a desired consistency using an agent based on polysaccharides or proteins. For example fecula, arrowroot, cornstarch, katakuri starch, potato starch, sago, tapioca, alginin, guar gum, locust bean gum, xanthan gum, collagen, egg whites, furcellaran, gelatin, agar, carrageenan, cellulose, methylcellulose, hydroxymethylcellulose, acadia gum, konjac, starch. pectin, amylopectin or proteins derived from legumes, grains, nuts, other seeds, leaves, algae, bacteria, of fungi can be used alone or in combination to thicken the gel, forming an architecture or structure for the food product.

In some embodiments, the fat component is an emulsion comprising a solution of one or more proteins and one or more fats suspended therein as droplets. In some embodiments, the emulsion is stabilized by one or more cross-linking enzymes into a gel. In more particular embodiments, the one or more proteins in solution are isolated, purified proteins. In yet more particular embodiments, the isolated, purified proteins comprise a purified pea albumin enriched fraction. In other more particular embodiments, the isolated, purified proteins comprise a purified pea globulin enriched fraction. In other more particular embodiments, the isolated, purified proteins comprise a purified Moong bean 8S globulin enriched fraction. In yet more particular embodiments, the isolated, purified proteins comprise a Rubisco enriched fraction. In other particular embodiments, the one or more fats are derived from plant-based oils In more particular embodiments, the one or more fats are derived from one or more of: corn oil, olive oil, soy oil, peanut oil, walnut oil, almond oil, sesame oil, cottonseed oil, rapeseed oil, canola oil, safflower oil, sunflower oil, flax seed oil, algal oil, palm oil, palm kemel oil, coconut oil, babassu oil, shea butter, mango butter, cocoa butter, wheat germ oil, rice bran oil, oils produced by bacteria, algae, archaea or fungi or genetically engineered bacteria, algae, archaea or fungi, triglycerides, monoglycerides, diglycerides, sphingosides, glycolipids, lecithin, lysolecithin, phophatidic acids, lysophosphatidic acids, oleic acid, palmitoleic acid, palmitic acid, myristic acid, laurie acid, myristoleic acid, caproie acid, capric acid, caprylic acid, pelargonic acid, undecanoic acid, linoleic acid, 20 1 eicosanoic acid, arachidonic acid, eicosapentanoic acid, docosohexanoic acid, 18:2 conjugated linoleic acid, conjugated oleic acid, or esters of: oleic acid, palmitoleic acid, palmitic acid, myristic acid, lauric acid, myristoleic acid, caproic acid, capric acid, caprylic acid, pelargonic acid, undecanoic acid, linoleic acid, 20:1 eicosanoic acid, arachidonic acid, eicosapentanoic acid, docosohexanoic acid, 18.2 conjugated linoleic acid, or conjugated oleic acid, or glycerol esters of oleic acid, palmitoleic acid, palmitic acid, myristic acid, lauric acid, myristoleic acid, caproic acid, capric acid, caprylic acid, pelargonic acid, undecanoic acid, linoleic acid, 20:1 eicosanoic acid, arachidonic acid, eicosapentanoic acid, docosohexanoic acid, 18.2 conjugated linoleic acid, or conjugated oleic acid, or triglyceride derivatives of oleic acid, palmitoleic acid, palmitic acid, myristic acid, lauric acid, myristoleic acid, caproic acid, capric acid, caprylic acid, pelargonic acid, undecanoic acid, linoleic acid, 20.1 eicosanoic acid, arachidonic acid, eicosapentanoic acid, docosohexanoic acid, 18:2 conjugated linoleic acid, or conjugated oleic acid. In yet even more particular embodiments, the one or more fats is a rice bran oil. In another particular embodiment, the one or more fats is a canola oil. In other particular embodiments, the cross-linking enzyme is transglutaminase, lysyl oxidase, or other amine oxidase. In yet even more particular embodiments, the cross-linking enzyme is transglutaminase. In particular embodiments, the fat component is a high fat emulsion comprising a protein solution of purified pea albumin emulsified with 40-80% rice bran oil, stabilized with 0.5-5% (wt/vol) transglutaminase into a gel. In particular embodiments, the fat component is a high fat emulsion comprising a protein solution of partially-purified moong bean 8S globulin emulsified with 40-80% rice bran oil, stabilized with 0.5-5% (wt/vol) transglutaminase into a gel. In particular embodiments, the fat component is a high fat emulsion comprising a protein solution of partially-purified moong bean 8S globulin emulsified with 40-80% canola oil, stabilized with 0.5-5% (wt/vol) transglutaminase into a gel. In particular embodiments, the fat component is a high fat emulsion comprising a protein solution of purified pea albumin emulsified with 40-80% rice bran oil, stabilized with 0.0001-1% (wt/vol) transglutaminase into a gel. In particular embodiments, the fat component is a high fat emulsion comprising a protein solution of partially-purified moong bean 8S globulin emulsified with 40-80% rice bran oil, stabilized with 0.0001-1% (wt/vol) transglutaminase into a gel. In particular embodiments, the fat component is a high fat emulsion comprising a protein solution of partially-purified moong bean 8S globulin emulsified with 40-80% canola oil, stabilized with 0.0001-1% (wt/vol) transglutaminase into a gel.

In some embodiments some or all of the components of the food product are suspended in a gel. In various embodiments the gel can be a hydrogel, an organogel, or a xerogel. The gel can be made thick using an agent based on polysaccharides or proteins. For example fecula, arrowroot, cornstarch, katakuri starch, potato starch, sago, tapioca, algmin, guar gum, locust bean gum, xanthan gum, collagen, egg whites, furcellaran, gelatin, agar, carrageenan, cellulose, methylcellulose, hydroxymethylcellulose, acadia gum, konjac, starch, pectin, amylopectin or proteins derived from legumes, grains, nuts, other seeds, leaves, algae, bacteria, of fungi can be used alone or in combination to thicken the gel, forming an architecture or structure for the food product. Enzymes that catalyze reactions leading to covalent crosslinks between proteins can also be used alone or in combination to form an architecture or structure for the food product. For example transclutaminase, lysyl oxidases, or other amine oxidases (e.g. Pichia pastoris lysyl oxidase (PPLO) can be used alone or in combination to form an architecture or structure for the food product. In some embodiments multiple gels with different components are combined to form the food product For example a gel containing a plant-based protein can be associated with a gel containing a plant-based fat. In some embodiments fibers or stings of proteins are oriented parallel to one another and then held in place by the application of a gel containing plant based fats.

In some embodiments the food product composition contains no animal protein, comprising between 10-30% protein, between 5-80% water, between 5-70% fat, and further comprising one or more isolated purified proteins. In particular embodiments, the food product compositions comprise transglutaminase.

In some embodiments the food product contains components to replicate the components of meat. The main component of meat is typically skeletal muscle. Skeletal muscle typically consists of roughly 75 percent water, 19 percent protein, 2.5 percent intramuscular fat, 1.2 percent carbohydrates and 2.3 percent other soluble non-protein substances. These include organic acids, sulfur compounds, nitrogenous compounds, such as amino acids and nucleotides, and morganic substances such as minerals. Accordingly, some embodiments of the present invention provide for replicating approximations of this composition for the food product. For example, in some embodiments the food product is a plant-based meat replica can comprise roughly 75% water, 19% protein, 2.5% fat, 1.2% carbohydrates; and 2.3 percent other soluble non-protein substances. In some embodiments the food product is a plant-based meat replica comprising between 60-90% water, 10-30% protein, 1-20% fat. 0.1-5% carbohydrates; and 1-10 percent other soluble non-protein substances. In some embodiments the food product is a plant-based meat replica comprising between 60-90% water, 5-10% protein, 1-20% fat, 0.1-5% carbohydrates; and 1-10 percent other soluble non-protein substances. In some embodiments the food product is a plant-based meat replica comprising between 0-50% water, 5-30% protein, 20-80% % fat, 0.1-5% carbohydrates; and 1-10 percent other soluble non-protein substances. In some embodiments, the replica contains between 0.01% and 5% by weight of a heme protein. In some embodiments, the replica contains between 0.01% and 5% by weight of leghemoglobin. Some meat also contains myoglobin, a heme protein, which accounts for most of the red color and iron content of some meat. In some embodiments, the replica contains between 0.01% and 5% by weight of a heme protein. In some embodiments, the replica contains between 0.01% and 5% by weight of leghemoglobin. It is understood that these percentages can vary in meat and the meat replicas can be produced to approximate the natural variation in meat. Additionally, in some instances, the present invention provides for improved meat replicas, which comprise these components in typically unnatural percentages.

### EXAMPLES

### Example 1

Phycocyanobilin (PCB) is a blue phycobilin, i.e., a linear tetrapyrrole chromophore found in cyanobacteria and in the chloroplasts of red algae, glaucophytes, and some cryptomonads. PCB can be obtained by cleaving the molecule from phycobiliproteins (PCB) present in the extract of Arthrospira platensis (Spirulina). There are mainly three methods mentioned in the literature for cleavage of PCB from blue-green algae: enzymatic hydrolysis, acid hydrolysis, and methanolysis. Enzymatic hydrolysis involved the cleavage of PCB from C-PC (purified from Phormidium luridum) by incubating the solution of C-PC in 0.25 M potassium phosphate (pH 7) buffer with 100 mg Nagarse enzyme at 37° C. for 16 h (Siegelman et al., 1967). PCB cleavage by acid hydrolysis consisted of dispersion of denatured C-PC into concentrated hydrochloric acid at 25° C. for 30 min followed by precipitation of free PCB from the mixture by dilution with water (O'heocha, 1958). In methanolysis, denatured C-PC is boiled in methanol at 60° C. for 16 h and free PCB from the resultant mixture is purified by extraction with chloroform (Carra and O'heocha, 1966; Chapman et al., 1968).

For the methods of the present invention, PBP containing PCB obtained by the methods described in the Description above and in PCT Appl. PCT/US2019/061709 which is incorporated by reference herein its entirety. Alternatively, PCB may be obtained by the methods in the preceding paragraph. The present methods involve reacting PCB with an iron donor to provide a heme-analog comprising a linear polycyclic tetrapyrrole consisting of a PCB molecule in a coordination complex with an Fe²⁺ ion. Thus, the chemical structure of the compound is that of a tetrapyrrole bound to and surrounding an iron ion, like that of heme.

The protein section of the compound consists of 4 substituted pyrroles bound to one another linearly, wrapped around a central iron (II) ion. It is produced through the solvolysis of the phycocyanin pigment in reflux, resulting in the tetrapyrrole, which is then reacted with an ionic compound featuring ferrous iron. Suitable iron species include, but are not limited to, H₂Fe(CO)₄, Na₂Fe(CO)₄, Fe(CO)₅, Fe₂(CO)₉, Fe₃(CO)₁₂, Fe(CO)₃CH₃COC₂H₂C₆H₆, FeH, Fe3C, FeBr₂, FeCl₂, FeF₂, FeI₂, FeH₂, FeMoO₄, FeO, Fe(OH)₂, FeS, FeSO₄, FeSe, FeSeO₄, FeSi₂, FeTiO₃, FeCO₃, FeC₂O₄, Fe(C₂H₃O₂)₂, Fe(C₃H₅O₃)₂, FeC₆H₆O₇, FeC₁₂H₂₂O₁₄, FeCr₂O₄, Fe₃(PO₄)₂, Fe(HCO₃)₂, Mg₂FeH₆, Fe(C₅H₅)₂, Fe(C₅H₄P(C₆H₅)₂)₂, C₄H₄Fe(CO)₃, C₄H₆Fe(CO)₃, Fe₃P, Fe₃O₄, Fe₃S₄, FeBr₃, FeCl₃, FeF₃, FeI₃, Fe(NO₃)₃, Tris(acetylacetonato) iron (III), FeOCl, FeO(OH), FePO₄, Fe₄(P₂O₇)₃, Fe₂(CrO₄)₃, Fe₂(C₂O₄)₃, Fe₂O₃, Fe₂S₃, Fe₂(SO₄)₃, FeBO₃, FeB, Fe(C₅H₅)₂BF₄, FeSi, FeGe, K₂FeO₄, and BaFeO₄.

The product is used various culinary settings to enhance the flavor of imitation meat, allowing it to take on a depth and character not otherwise achieved in the absence of animal products.

Properties of the iron-complexed PCB molecules of the present invention include, but are not limited to:
Molar mass: 641.535 amu (estimated)
Soluble in: Methanol, water
Color: Reddish brown
Odor: Meaty, Earthy

Quantities of 1 gram of phycocyanin per 100 ml of methanol are combined in a round bottom flask with a capacity of at least twice the amount of solution. A stir bar is introduced to the flask before it is placed into a heating mantle. A reflux column is secured to the top of the flask with necessary sealant and support clamps and allowed to fill with cold water (below 20° C.). A thermometer holder with a thermometer is secured to the top of the reflux column, with the tip of the thermometer reaching down into the reflux column to ensure that the temperature does not change unexpectedly during reflux. With water flowing through the column continuously, the stirring and heating functions of the mantel are turned on. Stirring should be vigorous enough to agitate the surface of the liquid. Heating should be sufficient to maintain a consistent low boil (the boiling point of methanol being ˜64° C.). The reaction should be allowed to continue without impeding the ability of condensed methanol to drop back into the solution, change in temperature of the thermometer (particularly sudden increases), or any other unexpected or spontaneous changes to the state of the solution or setup, in which case the process should be stopped immediately. After 16 hours have elapsed, the process can be stopped.

Once cooled and ready to be handled, mechanical filtration can be used to separate solid and liquid components of the solution. Both components should be retained as both are used in the final product. The liquid component of the solution, containing dissolved phycobiliproteins, can now have iron salts added for the synthesis of iron tetrapyrrole complexes to occur. Depending on the salt used, conditions for the reaction may be changed, namely by removing the dissolved proteins from methanol in order for a different solvent to be used, and/or through the introduction of reaction favoring compounds (most notably non-coordinating bases e.g., triethylamine) which will then need to be removed from the final product (most commonly through evaporation). Once the coordination complex has been produced and isolated, reintroduction of the solid component separated in an earlier step may occur.

For the creation of a food additive which affects a flavor reminiscent of fish and seafood (and for use in such culinary applications), a slightly different method of preparation is favored. Before the process is carried out, phycocyanin of our peculiar composition is subjected to a degree of oxidation, followed by the introduction of fermentative bacterial cultures of a proprietary nature which is then allowed to colonize the phycocyanin mixture. The process is then carried out identically, except with a slight increase in duration of reflux. At conclusion, the mixture should affect an aroma strongly reminiscent of seafood, particularly fish, rather than one of meat.

At present, NMR and MS have yet to be used in the characterization of the tetrapyrrole described herein. Nonetheless, a prediction of its chemical structure can be surmised until this data can be added.

NMR is anticipated to find a linear phycobilin largely resembling the starting compounds of the reaction, the differences being the dehydrogenation of some or all of the secondary amines present in the constituent pyrrole rings of the original tetrapyrrole, rendering them (1) tertiary amines, and (2) bound to an iron ion.

Claims:

1. A compound comprising phycocyanobilin in a coordinated complex with an iron ion.

2. The compound of claim 1, wherein the iron ion is an Fe2+ion.

3. The compound of any one of claims 1 to 2, wherein the phycocyanobilin is Spirulina phycocyanobilin.

4. The compound of any one of claims 1 to 3, wherein the compound has a molar mass of approximately 641.535 amu.

5. The compound of any one of claims 1 to 4, wherein the compound is soluble in a solvent selected from the group consisting of methanol and water.

6. The compound of any one of claims 1 to 5, wherein a solution of the compound in water or methanol has a reddish brown color.

7. The compound of any one of claims 1 to 5, wherein a dried powder of the compound has a reddish brown color.

8. A composition comprising iron-complexed phycocyanobilin compounds at concentration of from 0.01% to 99.9% w/w of the composition, wherein w/w is weight of the iron-complexed phycocyanobilin divided by the total weight of the composition.

9. The composition of claim 8, wherein the composition comprises 0.1% to 50% w/w of the iron-complexed phycocyanobilin compounds.

10. The composition of claim 8, wherein the composition comprises 0.1% to 20% w/w of the iron-complexed phycocyanobilin compounds.

11. The composition of claim 8, wherein the composition comprises 0.1% to 10% w/w of the iron-complexed phycocyanobilin compounds.

12. The composition of claim 8, wherein the composition comprises 0.1% to 5% w/w of the iron-complexed phycocyanobilin compounds.

13. The composition of any one of claims 8 to 12, wherein the iron-complexed phycocyanobilin compounds comprise tetrapyrrole phycocyanobilin in a coordinated complex with an iron ion.

14. The composition of claim 13, wherein the iron ion is an Fe2+ion.

15. The composition of any one of claims 8 to 14, wherein the phycocyanobilin is Spirulina phycocyanobilin.

16. The composition of any one of claims 8 to 15, wherein the iron-complexed phycocyanobilin compound has a molar mass of approximately 641.535 amu.

17. The composition of any one of claims 8 to 16, wherein the iron-complexed phycocyanobilin compound is soluble in a solvent selected from the group consisting of methanol and water.

18. The composition of any one of claims 8 to 17, wherein a solution of the iron-complexed phycocyanobilin compounds in water or methanol has a reddish brown color.

19. The composition of any one of claims 8 to 18, wherein a dried powder of the composition has a reddish brown color.

20. The composition of any one of claims 8 to 19, wherein the composition has a meaty odor.

21. The composition of any one of claims 8 to 20, wherein the composition has an earthy odor.

22. The composition of any one of claims 8 to 21, wherein the composition comprises a protein from a source other than Spirulina.

23. The composition of any one of claims 8 to 22, further comprising a plant protein.

24. The composition of claim 23, wherein the plant protein is selected from the group consisting of proteins from grains, oil seeds, leafy greens, biomass crops, root vegetables, and legumes.

25. The composition of claim 24, wherein the grains are selected from the group consisting of corn, maize, rice, wheat. barley, rye, triticale and teff.

26. The composition of claim 24, wherein the oilseeds are selected from the group consisting of cottonseed, sunflower seed, safflower seed, and rapeseed.

27. The composition of claim 24, wherein the leafy greens are selected from the group consisting of lettuce, spinach, kale. collard greens. turnip greens, chard, mustard greens, dandelion greens, broccoli, and cabbage.

28. The composition of claim 24, wherein the biomass crops are selected from the group consisting of switchgrass, miscanthus. sorghum, alfalfa, com stover, green matter, sugar cane leaves and leaves of trees.

29. The composition of claim 24, wherein the root crops are selected from the group consisting of cassava, sweet potato, potato, carrots, beets, and turnips.

30. The composition of claim 24, wherein the legumes are selected from the group consisting of clover, cowpeas. English peas, yellow peas, green peas, soybeans, fava beans. lima beans, kidney beans, garbanzo beans, mung beans, pinto beans, lentils, lupins, mesquite. carob, soy, and peanuts, vetch (vicia), stylo (stylosanthes), arachis. indigofera, acacia. leucaena, cyamopsis, and sesbania.

31. The composition of any one of claims 8 to 30, further comprising a fat from a source other than Spirulina.

32. The composition of claim 31, wherein the fat is selected from the group consisting of corn oil, olive oil, soy oil, peanut oil, walnut oil, almond oil, sesame oil, cottonseed oil, rapeseed oil, canola oil, safflower oil, sunflower oil, flax seed oil, algal oil, palm oil, palm kernel oil, coconut oil, babassu oil, shea butter, mango butter, cocoa butter, wheat germ oil, rice bran oil, an oil produced by bacteria, an oil produced by archaea, an oil produced by fungi, an oil produced by genetically engineered bacteria, an oil produced by genetically engineered algae, an oil produced by genetically engineered archaea, and an oil produced by genetically engineered fungi, and a mixture of two or more thereof.

33. The composition of any one of claims 8 to 32, further characterized in comprising between 10-30% w/w protein, between 5-80% w/w water, and between 5-70% fat

34. A food product containing the compound of any one of claims 1 to 7 or the composition of any ones of claims 8 to 33.

35. A multi-component food product comprising:
a first component comprising iron-complexed phycocyanobilin compounds at concentration of from 0.01% to 99.9% w/w of the composition, wherein w/w is weight of the iron-complexed phycocyanobilin divided by the total weight of the first component:
a second component comprising a non-animal protein from a source other than Spirulina.

36. The multi-component food product of claim 35, wherein the first component comprises 0.1% to 50% w/w of the iron-complexed phycocyanobilin compounds.

37. The multi-component food product of claim 35, wherein the first component comprises 0.1% to 20% w/w of the iron-complexed phycocyanobilin compounds.

38. The multi-component food product of claim 35, wherein the first component comprises 0.1% to 10% w/w of the iron-complexed phycocyanobilin compounds.

39. The multi-component food product of claim 35, wherein the first component comprises 0.1% to 5% w/w of the iron-complexed phycocyanobilin compounds.

40. The multi-component food product of any one of claims 35 to 39, wherein the iron-complexed phycocyanobilin compounds in the first component comprise tetrapyrrole phycocyanobilin in a coordinated complex with an iron ion.

41. The multi-component food product of claim 40, wherein the iron ion is an Fe2+ion.

42. The multi-component food product of any one of claims 35 to 41, wherein the phycocyanobilin is Spirulina phycocyanobilin.

43. The multi-component food product of any one of claims 35 to 42, wherein the iron-complexed phycocyanobilin compound has a molar mass of approximately 641.535 amu.

44. The multi-component food product of any one of claims 35 to 43, wherein the second component comprising a non-animal protein from a source other than Spirulina is a plant protein.

45. The multi-component food product of claim 44, wherein the plant protein is selected from the group consisting of proteins from grains, oil seeds, leafy greens, biomass crops, root vegetables, and legumes.

46. The multi-component food product of claim 45, wherein the grains are selected from the group consisting of com. maize. rice, wheat, barley, rye, triticale and teff.

47. The multi-component food product of claim 45, wherein the oilseeds are selected from the group consisting of cottonseed. sunflower seed, safflower seed, and rapeseed

48. The multi-component food product of claim 45, wherein the leafy greens are selected from the group consisting of lettuce, spinach, kale, collard greens. turnip greens, chard, mustard greens, dandelion greens, broccoli. and cabbage

49. The multi-component food product of claim 45, wherein the biomass crops are selected from the group consisting of switchgrass, miscanthus, sorghum, alfalfa, corn stover, green matter, sugar cane leaves and leaves of trees.

50. The multi-component food product of claim 45, wherein the root crops are selected from the group consisting of cassava, sweet potato, potato, carrots, beets, and turnips.

51. The multi-component food product of claim 45, wherein the legumes are selected from the group consisting of clover, cowpeas. English peas, yellow peas, green peas, soy beans. fava beans, lima beans, kidney beans, garbanzo beans, mung beans. pinto beans. lentils, lupins, mesquite, carob, soy, and peanuts, vetch (vicia). stylo (stylosanthes), arachis. indigofera, acacia, leucaena, cyamopsis, and sesbania.

52. The multicomponent food product of any one of claims 35 to 51, further comprising:
a third component comprising a fat from a source other than Spirulina.

53. The multicomponent food product of claim 52, wherein the fat is selected from the group consisting of corn oil, olive oil, soy oil, peanut oil, walnut oil, almond oil, sesame oil, cottonseed oil, rapeseed oil, canola oil, safflower oil, sunflower oil, flax seed oil, algal oil, palm oil, palm kernel oil, coconut oil, babassu oil, shea butter, mango butter, cocoa butter, wheat germ oil, rice bran oil, an oil produced by bacteria, an oil produced by archaea, an oil produced by fungi, an oil produced by genetically engineered bacteria, an oil produced by genetically engineered algae, an oil produced by genetically engineered archaea, and an oil produced by genetically engineered fungi, and a mixture of two or more thereof.

54. The multicomponent food product of any one of claims 35 to 53, further characterized in comprising between 10-30% w/w total protein, between 5-80% w/w water, and between S-70% fat

55. A method comprising:
providing a composition comprising phycocyanobilin; and
reacting the composition with an iron ion donor compounds to provide a phycocyanobilin compound in a coordinated complex with an iron ion.

56. The method of claim 55, wherein the iron ion is Fe2+.

57. The method of any one of claims 55 to 56, wherein the iron ion donor compound is selected from the group consisting of H2Fe (CO) +, Na2Fe (CO) +, Fe (CO) s, Fez (CO) 9, Fes (CO) 12, Fe (CO) 3CH3COC2H2C6H6, FeH, Fe3C, FeBr2, FeCl2. FeF2, Fel2, FeH2, FeMoO4, FeO, Fe (OH) 2, FeS, FeSO+, FeSe, FeSeO+, FeSi2, FeTiO3, FeCO3, FeC204, Fe (C2H302) 2, Fe (C3H503) 2, FeC6H607, FeC12H22014, FeCr204, Fes (PO4) 2, Fe (HCO3) 2, Mg2FeH6, Fe (CsH5) 2, Fe (CsH+P (C6H5) 2) 2, C+H+Fe (CO) 3, C4H6Fe (CO) 3, FesP, Fe304, FesS+, FeBr3, FeCl3, FeF3, Fel3, Fe (NO3) 3, Tris (acetylacetonato) iron (III), FeOCI, FeO (OH), FePO+, Fes (P207) 3, Fez (Cr04) 3, Fez (C204) 3, Fe203, FezS3, Fez (SO+) 3, FeBO3, FeB, Fe (CsH5) 2BF4, FeSi, FeGe, K2FeO+, and BaFeO+.

58. The method of any one of claims 55 to 57, wherein the composition comprising phycocyanobilin is a phycobiliprotein (PBP) composition.

59. The method of claim 58, wherein the PBP composition is characterized by one or more of the following characteristics:
a) the protein fraction of the composition comprises greater than about 30% of a protein having a molecular weight of about 17,695 kDa and an isoelectric point of about 6.29 as assayed by two dimensional gel electrophoresis followed by quantitation by densitometry:
b) the protein fraction of the composition comprises greater than about 5% of a protein having a molecular weight of about 19,833 kDa and an isoelectric point of about 6.14 as assayed by two dimensional gel electrophoresis followed by quantitation by densitometry:
c) the protein fraction of the composition comprises greater than about 1% of a protein having a molecular weight of about 45,578 kDa and an isoelectric point of about 6.2 as assayed by two dimensional gel electrophoresis followed by quantitation by densitometry:
d) the protein fraction of the composition comprises greater than about 1% of a protein having a molecular weight of about 35,014 kDa and an isoelectric point of about 5.9 as assayed by two dimensional gel electrophoresis followed by quantitation by densitometry:
e) the protein fraction of the composition comprises greater than about 0.30% of a protein having a molecular weight of about 24,688 kDa and an isoelectric point of about 5.3 as assayed by two dimensional gel electrophoresis followed by quantitation by densitometry:
f) the protein fraction of the composition comprises greater than about 2% of a protein having a molecular weight of about 22,522 kDa and an isoelectric point of about 5.9 as assayed by two dimensional gel electrophoresis followed by quantitation by densitometry:
g) the protein fraction of the composition comprises greater than about 1% of a protein having a molecular weight of about 21,023 kDa and an isoelectric point of about 7.3 as assayed by two dimensional gel electrophoresis followed by quantitation by densitometry:
h) the protein fraction of the composition comprises greater than about 0.50% of a protein having a molecular weight of about 13,417 kDa and an isoelectric point of about 7.3 as assayed by two dimensional gel electrophoresis followed by quantitation by densitometry:
i) the protein fraction of the composition comprises a ratio of major protein constituents to minor protein constituents of less than 3.5:1 based on the aggregate mass of the proteins, wherein major protein constituents are the protein having a molecular weight of about 17,695 kDa and an isoelectric point of about 6.29 as assayed by two dimensional gel electrophoresis followed by quantitation by densitometry and the protein having a molecular weight of about 19,833 kDa and an isoelectric point of about 6.14 as assayed by two dimensional gel electrophoresis followed by quantitation by densitometry and the minor protein constituents are the remainder of the proteins:
j) the protein fraction of the composition comprises less than about 75% on a mass basis of the combined amounts of the protein having a molecular weight of about 17,695 kDa and an isoelectric point of about 6.29 as assayed by two dimensional gel electrophoresis followed by quantitation by densitometry and the protein having a molecular weight of about 19,833 kDa and an isoelectric point of about 6.14 as assayed by two dimensional gel electrophoresis followed by quantitation by densitometry:
k) the composition produces a solution having a color value of greater than 200 E 10%/1 cm when 250 mg of a dry powder of the composition are dissolved in one liter of water and absorbance is measured at 618 nm.

60. The method of any one of claims 55 to 59, wherein the composition comprising phycocyanobilin is produced by:
encapsulating Spirulina to provide capsules: and contacting the capsules with an aqueous medium under conditions such that PCB containing PBP passes from the capsule into the aqueous solution.

61. The method of claim 60, wherein the step of encapsulating Spirulina to provide capsules comprises:
mixing dried or fresh Spirulina with water and multivalent cations to provide a first solution; and
forming the capsules by dropping the first solution into a second solution comprising a gelling agent.

62. The method of any one of claims 55 to 61, further comprising formulating a food product by combining the phycocyanobilin compound in a coordinated complex with an iron ion with a protein composition that is not obtained from Spirulina.

63. The method of claim 62, further comprising combining the phycocyanobilin compound in a coordinated complex with an iron ion and the protein composition that is not obtained from Spirulina with a fat that is not obtained from Spirulina.

64. A method of making a food product comprising:
providing a first component comprising iron-complexed phycocyanobilin compounds at concentration of from 0.01% to 99.9% w/w of the composition, wherein w/w is weight of the iron-complexed phycocyanobilin divided by the total weight of the first component and a second component comprising a non-animal protein from a source other than Spirulina; and
forming the first component and the second component into a food product.

65. The method of claim 64, further comprising providing a third component comprising a fat from a source other than Spirulina and forming the first, second and third components into a food product.
